(19) United States
(12) Patent Application Publication
(10) Pub. No.: US 2003/0046537 A1
(43) Pub. Date: Mar. 6, 2003

(54) Method and system for authorization control of displayed content

(76) Inventor: Joshua Edward Smith, Barre, MA (US)

Correspondence Address: MINTZ, LEVIN, COHN, FERRIS,, GLOVSKY and POPEO, P.C., One Financial Center, Boston, MA, 02111, US

(21) Appl. No.: 10/188,196

(22) Filed: Jul. 1, 2002

Related U.S. Application Data
(60) Provisional application No. 60/315,430, filed on Aug. 28, 2001.
(60) Provisional application No. 60/308,361, filed on Jul. 27, 2001.

(51) Int. Cl. H04L 9/00

(52) U.S. Cl. 713/161

(57) ABSTRACT

The system and method of the present invention use public key cryptography to ensure that content provided to a rendering platform has been properly authorized and licensed. Once the content is created, a digital signature is generated based upon at least a portion of the content using a private key. The private key is stored in a secure server separate from the content development environment. The rendering platform uses a corresponding public key to check authentication of the content prior to display. The system also allows different levels of rendering based upon the creation of the digital signature.

### CROSS-REFERENCE TO RELATED APPLICATIONS

This application claims the benefit of priority to U.S.S. No. 60/315,430 filed Aug. 28, 2001, and U.S.S. No. 60/308,361 filed Jul. 27, 2001, which are incorporated herein by reference in their entirety.

### STATEMENT REGARDING FEDERALLY SPONSORED RESEARCH

Not Applicable

### REFERENCE TO MICROFICHE APPENDIX

Not Applicable

### BACKGROUND OF THE INVENTION

The present invention is directed toward a display system and method for preventing display of unauthorized or unlicensed content. In particular, it relates to a system which ensures that content has been licensed and authorized prior to display in a rendering environment.

Most content security systems have been designed to prevent the unauthorized viewing of content by certain users. In such systems, the user desires access to certain content. Control systems are used to ensure that the user is entitled to access the content. For example, user names and passwords are used to prevent unauthorized users from accessing certain content. The name and password entered by the user are compared with stored information to determine whether access should be allowed. If access is to be allowed, then the content is provided to the user. Other such systems also attempt to control what an authorized user can do with the content once it has been accessed. However, these types of systems are designed to operate in an environment in which the content users desire the content. Often, the content creator wishes to distribute the content widely, but some other party wishes to control the distribution. For example, creators of rendering and content creation platforms may exercise control over the distribution of content created or rendered with the platform. Typical content security systems do not allow for such control.

More recently, digital signatures have developed as another type of security mechanism. With a digital signature, the recipient of content can verify a source of the content and the authenticity of the content. Digital signatures use public/private key cryptographic techniques. A content creator encodes a portion of the content with a private key. An available public key can be used to decode the portion of the content. If the encoded content decodes properly and corresponds to the remainder of the content, then the entire content can be considered to have come from the entity to which the public key corresponds and to have been unaltered. However, digital signatures have not been used to control the dissemination of content by creators. While the content creator could use a digital signature to prevent alteration of the content, it does not provide a third party with control of the content dissemination.

The most common business model for developers of digital content rendering platforms is to give the platform away for free. Subsequently, the developers generate revenue through sales of software which enables content creators to easily publish digital content for that platform. For example, the Macromedia “Flash Player” is a free rendering platform which is factory-installed on most computers. Macromedia then sells the “Flash” authoring tools to create content for this viewer. This business model functions well because content creators want to provide interesting content to users who are unknown. The development platform allows the creators to generate interesting content. However, a specific type of program, the rendering platform, is necessary to view the content. Since the rendering platform is available for free, many users can access the content.

One drawback of this business model is that the rendering platform can function with content which is not created using the development platform. In most cases, there is nothing which prevents others from creating content which will play on a given rendering platform. Furthermore, there is nothing to prevent competing companies from providing competing development platforms for creating content to be displayed with a given rendering platform. Since the original development platform is priced to also recover the costs of creating the rendering platform, the competing company can undercut prices. For example, Adobe sells “After Effects” which can produce content for the “Flash Player”, thus cutting Macromedia out of the revenue stream for some portion of content authors. Designing a rendering platform is a labor-intensive task. It is, therefore, desirable to ensure that some of the money expended in designing rendering platforms is recovered by allowing only authorized content to be displayed by the rendering platform. Therefore, a need exists for a system which permits the designer of the rendering platform to control the process for content creation.

Various legal mechanisms have been attempted for protection of authoring and redering platforms and environments. However, these mechanisms generally do not provide sufficient protection. Attempts to use copyright law to protect file formats have been unsuccessful. In some cases, such as for MP3 audio files, patent protection has been successfully used to prevent the creation of unlicensed authoring environments. However, even in these cases, policing and enforcement activities can be very expensive, and in some jurisdictions, patent enforcement is virtually impossible. Finally, the new protections against reverse engineering afforded in the Digital Millennium Copyright Act have not yet been tested in the area of file formats, and regardless would only apply in the US. Therefore, a need exists for a technical mechanism to control authorization of content to be used in a rendering environment.

### SUMMARY OF THE INVENTION

The present invention substantially overcomes the deficiencies of the prior art by using public-key cryptographic protocols and algorithms in a novel manner to provide control content displayed on a rendering platform. Rather than relying on tenuous legal protections to prevent development of competing authoring environments, the present invention provides a system and method to ensure that only content created using an authorized development platform will play on a given rendering platform. According to one aspect of the present invention, the publicly available rendering platform includes a public key used to decode content to be displayed. If the content does not decode properly, it is considered to be unauthorized and will not display. According to another aspect of the invention, unauthorized content may be displayed in a limited manner. According to another aspect of the invention, different encoding mechanisms can be used to represent different display capabilities. Thus, upon content decoding, the rendering platform may display the content with different levels of detail based upon the encoding.

According to another aspect of the invention, a private key that is used to “sign” digital content is not part of the software used by the content creator to create his or her content. The signature function is performed by the platform developer upon request of the content creator. In this way, the security of the key is protected. It would likely be unfeasible to protect the key in a non-trusted computing environment, such as in distributed software. The private key is stored on a central computer that can be accessed via the Internet or a similar public network to provide the signature. A content author uses a software tool to communicate his or her digital content, or a summary thereof, to this central computer, where the private key is used to produce a digital signature. This digital signature is returned to the content creator's computer, where it is combined with the digital content for subsequent transmission to the desired rendering platform. According to another aspect of the invention, a separate license fee is charged at the time the signature is provided to the content creator.

According to another aspect of the invention, the signature relates to or by a portion of the digital content. This allows some modification to the content without the need for re-signing. According to another aspect of the invention, the signature is applied to statistical information pertaining to, or a digital summary of, the content to be rendered in lieu of applying the signature to the entire file containing the content. A summary of the content minimizes the amount of data communicated to the central computer for signature computation.

According to another aspect of the invention, different keys, or multiple different signature methods, can be used to allow a single rendering platform to support different levels of functionality within that content type. For example, a 3D rendering platform could support two levels of signature: an inexpensive signature which enables the display of untextured 3D models, and a more expensive signature which enables the display of fully textured 3D models. Similarly, in a platform for the rendering of audio content higher fees could be charged for larger audio bit rates.

### BRIEF DESCRIPTION OF THE DRAWINGS

FIG. 1 is a block diagram of a system for creation, authorization and rendering of content according to an embodiment of the present invention.

FIG. 2 represents a summary used to prepare a digital signature.

FIG. 3 illustrates the ordering of vertices.

### DETAILED DESCRIPTION

The present invention uses Public Key cryptography to ensure that the users seeking to provide content for a particular rendering platform obtain the proper authorizations and pay necessary licensing fees associated with use of the rendering platform. In this way designers of rendering platforms can recoup some of the costs associated with creating state-of-the-art rendering platforms, and content creators can display their digital content on state-of-the-art rendering platforms.

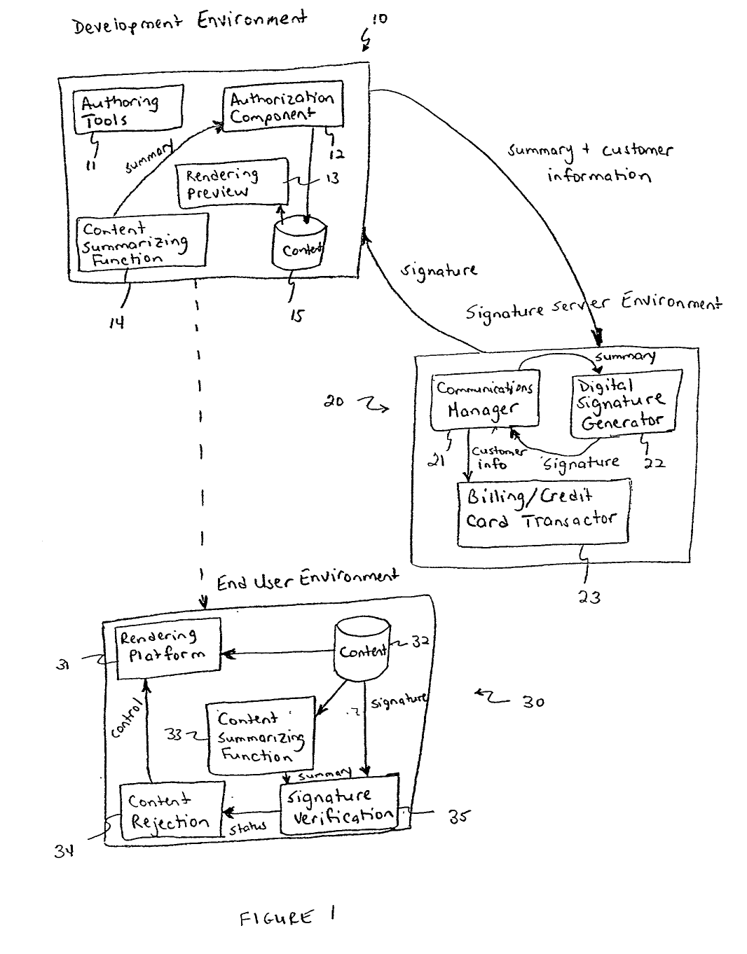

FIG. 1 is a block diagram representing the principal elements of an authorization system according to an embodiment of the present invention. The system of the present invention includes three main environments or platforms: a development environment 10, a rendering environment 30, and an authorization or signature server environment 20. The development environment 10 and rendering environment 30 include many functions commonly known with respect to such environments. For example, the development environment 10 includes authoring tools 11 used to create content 15. A previewer 13 is used by the creator to view the content 15 created using the authoring tools. The authoring tools 11 are designed to provide the creator with simple processes for creating content. In addition to typical components for creating content, the development environment of the present invention includes components for obtaining proper authorization information to be combined with the content 15. These components are discussed below in connection with the authorization process of the present invention.

The rendering or end user environment 30 displays the content for a user. The creator has to transfer 18 the content to the end user user. Different mechanisms can be used to provide the content to the end user environment 30. According to one embodiment of the invention, the creator stores the content 15 on a server where it is accessible by the user through a network, such as the Internet. According to other embodiments, the content could be provided on a tangible medium such as a diskette or CD-ROM. Independent of the transfer mechanism, a copy of the content 32 is available at the end user environment 30. The end user environment 30 includes a rendering platform 31 for presenting the content 32 to the user. The rendering platform is of a form which corresponds to the type of content 32 to be presented. It may include known platforms, such as Macromedia's Flash Player, or new platforms. The end user environment 30 also includes components for determining whether the content has been properly authorized. These components, discussed in detail below, control operation of the rendering platform 31 to prevent unauthorized content from being presented to the user. According to an embodiment of the present invention, the content 32, as transferred from the development environment 10, includes a digital signature which can be decoded with a public key included in the end user environment 30. The rendering platform 31 will only present the content 32 to the user if the digital signature is correct.

The third principal element of the system of the present invention is a signature server environment 20. The signature server environment 20 is used to properly authorize the content. As illustrated in FIG. 1 and discussed below, the signature server environment 20 is physically separate from the development environment 10. Thus, the developer of the system can control the authorization process. Alternatively, the signature server environment 20 could be included with the software which forms the development environment 10. However, this would increase the possibility of security breaches. As discussed in greater detail below, the signature server environment 20 receives 17 the content 15 or a summary of the content 15 from the development environment 10. The signature server environment 20 ensures that the development environment and the creator were properly authorized to create the content. Additionally, the signature server environment 20 may collect a licensing fee or monitor proper payments of charges in connection with determining that the content has been properly authorized. Once the content or summary of the content has been properly authenticated and authorized, the signature server environment 20 returns 28 a signature to the development environment. According to a preferred embodiment, the signature is created using the content or summary of the content and a private key known solely within the signature server environment. The development environment combines the signature with the content 15.

Authorization Process

The signature server environment 20 performs an authorization process to provide a digital signature for content provided by the development environment. As illustrated in FIG. 1, the signature server environment 20 may include various components, such as a communications manager 21, a billing/credit card transactor 23 and a digital signature generator 22. The communications manager 21 is used to communicate with the development environment 10. Information regarding the content 15 and customer information is transferred 17 from the development environment 10. The content information could be a summary of the content 15, or all or some portion of the content. This information can be transferred in any known manner. According to a preferred embodiment, the information is transferred through a public network such as the Internet. The communications manager 21 also transmits 28 the digital signature to the development environment to be combined with the content. According to an embodiment of the invention, the content summary is passed to the signature server environment 20 as an HTTP request into a Java servlet. The resulting signature is passed back to the development environment 10 as the return value of that HTTP request. The digital signature is created by the digital signature generator 22. A digital signature is generated in any known manner using the content summary or information and a private key stored in the digital signature generator 22. The content summary is transferred to the digital signature generator 22 from the communications manager 21 as received from the development environment 10.

The present invention uses a public/private key signature process to provide the digital signatures for authorization. Such processes are well known. An example is the Diffie-Hellman style public/private key pair disclosed in U.S. Pat. No. 4,200,770, incorporated herein by reference. In a preferred embodiment, the digital signature private key is encrypted in source code using the RC4 symmetric cypher. A password can be required at initialization of the digital signature generator program to decrypt the secret key for use at execution time. In this manner, the private key remains secure. In a preferred embodiment, a RSA public key encryption algorithm, which could be implemented using the Biglnteger class defined in the Java math package, is used to generate the digital signature from the content summary. A RSA KeyPairGenerator class provided in the Java 2 java.security package is used to create the private and public keys to be-used in the system of the present invention. This class is invoked once for the generation of a 1024 bit key. Other embodiments could use different public-key-cryptography implementations, such as DSA, ECC, or NTRU. In the preferred embodiment, as discussed below, the content summary, as received from the development environment 10, is a 160-bit SHA-1 hash of certain content information. To generate the digital signature, the 160-bit SHA-1 hash is padded to a length commensurate with the length of the private key, by appending 856 bits of random data. The resulting 1016 bit number is then run through a modular exponentiation operator. The following bit of Java code is exemplary of the process to generate the digital signature:

BigInteger rPri = new BigInteger(privateExponent,36);
BigInteger nPri = new BigInteger(privateModulus,36);
int plainBlockSize = (nPri.bitLength()-1)/4;//In nibbles
SecureRandom rand = new SecureRandom();
rand.setSeed(System.currentTimeMillis());
StringBuffer sb = new StringBuffer(fingerprint);
while (sb.length() <plainBiockSize)

sb.append(Integer.toHexString(rand.nextInt()&0xf));

BigInteger plainText = new BigInteger(sb.toString(), 16);
BigInteger cipherText = plainText.modPow(rPri, nPri);
String signature = cipherText.toString(36);

The privateExponent, privateModulus, and signature are all encoded as character strings in base 36 for compactness. Of course other processes could be used to generate the digital signature within the system of the present invention.

The billing/credit card transactor 23 is used to ensure that the content is properly authorized and licensed prior to generation of the digital signature. Customer information from the development environment 10 is provided to the billing/credit card transactor 23 by the communications manager 21. The customer information may include a customer identifier, password, registration or serial number for the development environment and/or other information which verifies the identity of the customer who provided the content or content summary. The billing/credit card transactor 23 compares the received customer information with information in a database to determine whether the customer has an authorized development environment. If the customer information is not found in the database, a digital signature will not be generated for the content. In this manner, only authorized customers can obtain a digital signature. In a preferred embodiment, the billing/credit card transactor 23 is also used for collection or accounting of license fees. According to this business model, a customer purchases the software of the development environment for a fee and also pays a license fee for each file of content which receives a digital signature. The billing/credit card transactor 23 performs the necessary financial transactions to collect the licensing fees, such as credit-card billing or simply noting a debit in an account in a general ledger for future processing by accounting software.

Other mechanisms could also be used for collecting licensing fees. For example, a customer may pay a single amount for any number of content files within a given timeframe. A customer may prepay for a certain number of content files, with the numbers being monitored by the billing/credit card transactor 23. Also, the fees are not required to be a single amount for all customers or contents. Different seal levels can be used, each with a different associated cost. In this manner, a customer may select different levels of functionality within the rendering platform. For example, with a 3D rendering platform, a less expensive seal may provide display of only untextured 3D models by the rendering platform, while a more expensive seal provides for display of fully textured 3D models. Other seals could be used for other types of content. For example, with an audio or video rendering platform, the fees could be based upon the required bit rates in the audio or video content. The seal levels can be set as part of the content summary, or could be differentiated by different hash functions, different keys, or different salt values in the hash function. However the fees are determined or collected, the digital signature generator only creates a digital signature once a determination has been made that the customer and content are properly authorized to obtain the digital signature.

Development Process

The development environment 10 allows a user to create content be displayed on the rendering platform. The present invention is not limited by the type of content to be created or rendered. Such content may include textured 3D models, compressed digital audio, 2D vector-based animation, 2D raster-based animation, an electronic book or magazine, computer software, or a game. The authoring tools 11 and the rendering platform 31 are designed to be compatible and operate on the same types of content. Once the content has been created using the authoring tools 11, the authorization component 12 of the development environment 10 obtains a digital signature from the signature server environment 20. As noted above, the digital signature may be obtained through an HTTP request to a physically distinct server. Alternatively, the digital signature generator 22 could form a part of the development environment 10, if appropriate safeguards are included to maintain the security of the private key and appropriate accounting functions are performed for collection of necessary license fees.

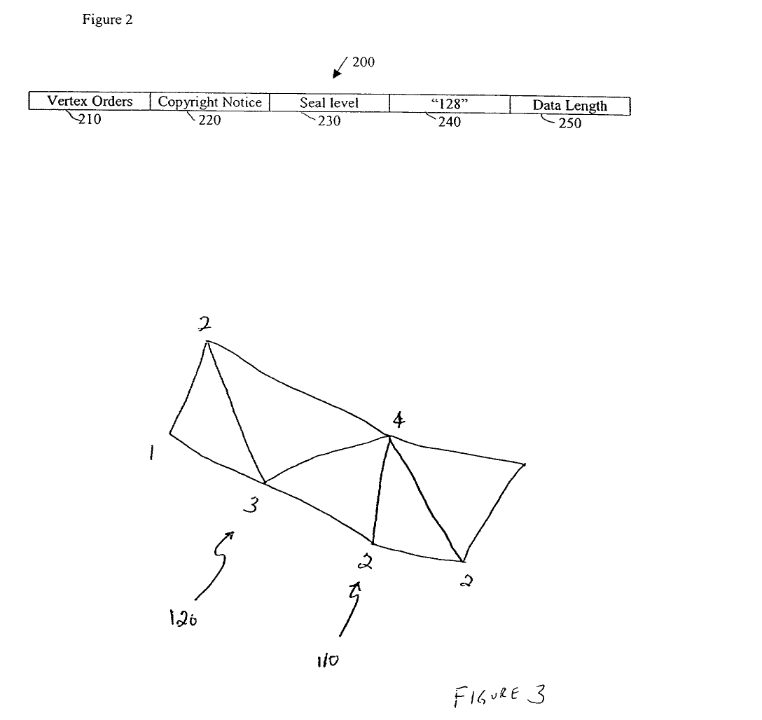

In order to ensure that content has been properly signed, a digital signature is created based upon the specific content to be signed. One embodiment of this function is as simple as passing the entirety of the content to be rendered thru a cryptographic hash. For example, the SHA-1 cryptographic hash algorithm can be used. The SHA-1, as distinguished from the original SHA specification, wherein the NSA-1 bit rotate recommendation is used. In this embodiment, the SHA-1 is comprised of a 160 bit message digest algorithm and is written in Java. In a preferred embodiment, however, which allows enhanced performance and limited modification of the content after the signature has been generated, a statistical summary of the content is created. This summary contains a statistical summary of the topology of the content to be rendered. The changes that can be made after a signature is acquired could be restricted to only those changes that do not impact the underlying topology of the object, i.e., the way the 3D vertex values are connected with edges and faces. In this embodiment, only the statistical summary of the digital content could be signed. When content is to receive a digital signature, the authorization component 12 obtains a summary of the content from the content summarizing function 14. Various summaries could be used to represent the content. According to an embodiment of the invention, as illustrated in FIG. 2, the summary 200 could be generated as follows:

1. The first part of the summary 210 is the number of vertices having specific order values. An “order” value is assigned to each vertex in the model to be rendered. This order value depends upon the number of triangles in the model that uses a particular vertex. FIG. 3 shows a model with several vertices. The order of the vertex is written below the vertex. The vertex shown by reference numeral 110 has an order value of 2 because two triangles share that vertex. Similarly, the vertex depicted by reference numeral 120 has an order of 3 because three triangles share that vertex. Vertices that have no triangles using them are not really part of the model and are ignored in creating the summary. The total number of each order are stored in a table containing thirteen values. Modular arithmetic could be used to overlap the counts for those rare cases where more than 12 vertexes are incident. A sample of pseudo-code used to create the table follows:

for each vertex

increment table [vertex.order % 13]

2. Additionally, a summary of the copyright notice 220 could be included in the content summary, thereby reducing the likelihood that the content could be tampered with. The characters of the copyright could be folded together, using exclusive-or logic for example, into the first element of the table generated in the previous step. The following bit of Java code shows an implementation of this embodiment wherein W[ ] is the array holding the table:

String copyright = properties.getProperty(“copyright”,“”);
int ww = W[0]+copyright.length();
for (int i=0;i<copyright.length();++i)

ww = rotateL(ww, 7)ˆ (copyright.charAt(i)&0x7f);

W[0]= ww;

In this implementation, the rotateL function rotates the bits in the integer to the left by the specified amount.

3. The next byte 230 in the summary 200 holds a character code indicating the “Seal Level” that the signature verification component could test to ensure the features of the viewer are in concert with the specific level obtained. In a preferred embodiment, a three letter code could be used to differentiate between different levels of access. For example, ‘L’, meaning “Light” seal, may allow the display of geometry, but not texture; ‘S’ for a “Standard” seal, could allow the display of textured geometry; and ‘D’ for a “Deluxe” seal, could permit the display of textured geometry in a viewer that does not display a logo. The following bit of Java code shows an implementation, where ‘level’ contains the letter code described above:

W[13]=(level<<8)10×80;

W[14}0;

W[15]=32*14_{—}8;

4. The next byte 240 is set to a constant, i.e. 128.

5. The remaining eight bytes 250 hold the length, in bits, of the data to be hashed.

The summary 200 described above is exactly 512 bits long, which is the standard encoding block size used by the SHA-1 algorithm. Therefore, the SHA-1 mixing functions could be applied to the table directly. The result would be a 160-bit sequence containing a cryptographic hash. Of course, other processes could be used to generate a summary of the content for purposes of obtaining a digital signature. Similarly, other hashing algorithms, such as MD2 or MD5, could be used.

A rendering preview component 13 is used in the development environment 10 to view the content. This component may simply be a version of the rendering platform 31. However, the rendering platform, as discussed below, requires a proper digital signature. The user may wish to preview the content before obtaining the necessary digital signatures or after changes have been made which require a new digital signature. One way the content creator could view his work before obtaining the necessary digital signatures is by using a special version of the rendering environment that does not require a digital signature or seal. In an alternate embodiment, the rendering environment allows content stored locally to be treated differently than it treats content being transmitted over the Internet or similar public network.

Rendering Process

The rendering environment 30 used in conjunction with this invention can be any application that takes content and renders it for use by an end user. In a preferred embodiment the rendering environment is a 3D rendering environment deployed as a Java Applet. In this embodiment, the content rendered is a textured 3D model of an object. The rendering platform thus translates this 3D data into a series of images that provide the user with various views of the 3D model. The views depicted are controlled by the user. The 3D images are generated in quick succession, giving the impression of a fully animated, dynamic 3D environment.

Prior to rendering the content, the rendering environment 30 checks the digital signature to determine whether the received content has been properly authorized. The rendering environment 30 includes a signature verification component 35, which includes the public key embedded within it. In an illustrative embodiment this key is stored as a character string encoding a base 36 number. The verification process is performed by taking the digital signature and decoding it using the public key. The rendering environment 30 also includes a content summarizing component 33 which operates identically to the content summarizing function 14 of the development environment 14. This component determines the proper summary of the content. The first 160 bits of the decrypted string from the digital signature are compared to the 160 bit SHA-1 hash from the summarizing component 33, to see if they match exactly. If so, then the signature presumably was created using the appropriate private key and the content is considered to be authorized.

As noted above, the rendering environment 30 supports the use of different “Seal levels.”The varying “Seal levels” correspond to different content summarizing and hash functions. The digital signature verification function 35 tests each possible Seal level in order to find one that matches. In this way, this function can ensure that the appropriate level of access is granted. The following steps are illustrative of the verification function performed in the signature verification component 35:

0. Decrypt the digital signature;

1. Generate Content Summary table using ‘L’ as seal level;

2. Hash with SHA-1;

3. Compare to the decrypted signature;

4. If it is a match, determine if a Light seal is adequate for the content and exit;

5. Generate Content Summary table using ‘S’ as seal level;

6. Hash with SHA-1;

7. Compare to the decrypted signature;

8. If it is a match, determine if a Standard seal is adequate for the content and exit;

9. Generate Content Summary table using ‘D’ as seal level;

10. Hash with SHA-1; and

11. Compare to the decrypted signature.

After these steps have been carried out, the seal level used to generate the signature is properly determined. The Seal level is used to determine which software features should be made available to display the content. Alternatively, the seal level can determine if content should be allowed to be viewed in this rendering environment as configured.

If the digital signature is not correct or the seal level is not appropriate, a content rejection component 34 disables the rendering platform 31 in some way. For example, if the content has no seal, but it is coming from a user's local disk, as may be the case in a development context for example, a warning message is placed on top of the rendered image. Alternatively, if the content had no seal and was coming in over the network, or if the seal on the content was not valid at any seal level, indicating an attempt to counterfeit a seal, the rendered image is modified in such a way that it would barely be visible. This is done by making the second pixel red, and every third pixel blue, resulting in a “screen door” effect. Additionally, a warning message is placed on top of the rendered image. The web browser that hosts the rendering application could also be directed to create a new browser window explaining the violation of the license. Additionally, the provider of the rendering environment could be notified thought the network that a violation has occurred and information regarding the violation. Many other alternatives for handling of improper digital signatures could also be used.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A system for authenticating digital content to be displayed by a rendering platform comprising:
means for receiving at least a portion of digital content to be authenticated and information relating to the source of the digital content;
means for determining whether the digital content is authorized based upon the information relating to the source of the digital content;
a digital signature generator creating a digital signature based upon at least a portion of digital content to be authenticated and a private key if the digital content is authorized;
means for combining the digital signature with the content;
means for decoding the digital signature using a public key associated with the private key; and
a rendering platform for displaying the digital content based upon the decoded digital signature.

2. The system for authenticating digital content to be displayed by a rendering platform according to claim 1, wherein the means for determining whether the digital content is authorized includes a billing system for charging the source of the digital content a fee associated with generation of the digital signature.

3. The system for authenticating digital content to be displayed by a rendering platform according to claim 1, wherein the means for determining whether the digital content is authorized includes means for confirming the identity of the source of the digital data.

4. The system for authenticating digital content to be displayed by a rendering platform according to claim 1, further comprising means for performing a hashing function on the at least a portion of the digital content prior to creating the digital signature.

5. The system for authenticating digital content to be displayed by a rendering platform according to claim 1, wherein the digital signature generator includes:
a plurality of means for creating digital signatures, each of the means creating a different digital signature; and
means for selecting one of the plurality of means for creating digital signatures to create the digital signature for the digital content based upon a desired level of service; and
wherein the rendering platform includes:
means for determining the desired level of service based upon decoding the digital signature, and
means for displaying the digital content according to the desired level of service.

6. The system for authenticating digital content to be displayed by a rendering platform according to claim 5, wherein the means for determining whether the digital content is authorized includes a billing system for charging the source of the digital content a fee associated with generation of the digital signature, and wherein the amount of the fee depends upon the desired level of service.

7. The system for authenticating digital content to be displayed by a rendering platform according to claim 1, wherein the rendering platform prohibits display of the digital content based upon the decoded digital signature.

8. The system for authenticating digital content to be displayed by a rendering platform according to claim 7, wherein the rendering platform displays a message regarding authentication when display of the digital content is prohibited.

9. The system for authenticating digital content to be displayed by a rendering platform according to claim 1, further comprising:
a development environment for creating the digital content, wherein the development environment includes:
means for creating the portion of the content from the digital content; and
means for transmitting the portion of the digital content to the means for receiving; and
wherein the means for combining the digital signature with the content is part of the development environment.

10. The system for authenticating digital content to be displayed by a rendering platform according to claim 9, wherein the means for creating the portion of the digital content creates a summary of the digital content as the portion.

11. The system for authenticating digital content to be displayed by a rendering platform according to claim 10, wherein the means for creating the portion of the digital content includes means for performing a hashing function on the summary of the digital content.

12. A method of authenticating digital content to be displayed by a rendering platform comprising the steps of:
determining whether the digital content is authorized based upon a source of the digital content;
generating a digital signature based upon at least a portion of the digital content and a private key, if the digital content is authorized;
combining the digital signature with the digital content;
transferring the combined digital signature and the digital content to the rendering platform;
decoding the digital signature using a public key associated with the private key; and
displaying the digital content based upon the decoded digital signature.

13. The method of claim 12, further comprising a step of charging the source of the digital content a fee associated with generation of the digital signature.

14. The method of claim 12, wherein the step of generating the digital signature includes the steps of:
selecting a desired level of service; and
generating the digital signature based upon the desired level of service; and
wherein the method further comprises, following the decoding step, the step of determining the desired level of service based upon decoding the digital signature; and
wherein the displaying step includes displaying the digital content according to the desired level of service.

15. The method of claim 14, further comprising a step of charging the source of the digital content a fee associated with generation of the digital signature based upon the desired level of service.

16. The method of claim 12, further comprising a step of displaying an error message based upon the decoded digital signature.

17. The method of claim 12, further comprising a step of creating a summary of the digital content as the at least a portion of the digital content.

18. The method of claim 17, further comprising a step of performing a hashing function on the summary of the digital content prior to generating the digital signature.

19. A system for controlling display of digital content comprising:
a development environment for creating the digital content and for combining the digital content with a digital signature;
an authentication environment, receiving at least a portion of the digital content from the development environment, for generating the digital signature based upon the at least a portion of the digital content and a private key and for providing the digital signature to the development environment; and
a rendering environment, having a public key associated with the private key, receiving the digital content and digital signature from the development environment, for displaying the digital content if the digital signature can be decoded using the public key.

20. The system for controlling display of digital content according to claim 19, wherein the authentication environment is a server which communicates with the development environment through a network.

21. The system for controlling display of digital content according to claim 19, wherein the authentication environment includes means for determining the authenticity of the development environment upon receipt of the portion of the digital content.

22. The system for controlling display of digital content according to claim 19, wherein the authentication environment includes means for assessing a fee to a user of the development environment prior to generating the digital signature.

23. The system for controlling display of digital content according to claim 19, wherein the rendering environment prohibits display of the digital content if the digital signature cannot be decoded using the public key.

24. The system for controlling display of digital content according to claim 19, wherein:
the authentication environment generates the digital signature based upon a desired level of service, and
the rendering platform displays the digital content according to the desired level of service.

25. The system for controlling display of digital content according to claim 19, wherein the development environment includes:
means for creating a summary of the digital content, and
means for transmitting the summary of the digital content to the authentication environment as the at least a portion of the digital content.

26. The system for controlling display of digital content according to claim 25, wherein the means for creating a summary of the digital content includes means for performing a hashing function of the summary of digital content.
